(19) United States
(12) Patent Application Publication
(10) Pub. No.: US 2019/0072375 A1
(43) Pub. Date: Mar. 7, 2019

(54) OPTICAL IMAGE MEASURING APPARATUS

(71) Applicant: HITACHI, LTD., Tokyo (JP)

(72) Inventor: Kentaro OSAWA, Tokyo (JP)

(21) Appl. No.: 16/010,538

(22) Filed: Jun. 18, 2018

(30) Foreign Application Priority Data
Sep. 6, 2017 (JP) 2017-171563

(51) Int. Cl. G01B 9/02; G01N 15/02

(52) U.S. Cl. CPC G01B 9/02041; G01N 15/0227; G01B 9/02091

(57) ABSTRACT

An optical image measuring apparatus according to the present invention includes an optical branching unit that branches light emitted from a light source into a signal light and a reference light, and an optical scanning unit that scans an angle of an optical axis emitted from the light source is disposed between the light source and the optical branching unit.

### CROSS-REFERENCE TO RELATED APPLICATION

This application claims the priority of Japanese Patent Application No. 2017-171563 filed Sep. 6, 2017, which is incorporated herein by reference in its entirety.

### BACKGROUND OF THE INVENTION

### 1. Field of the Invention

The present invention relates to an optical image measuring apparatus for observing a measurement object using light.

### 2. Description of the Related Art

Optical coherence tomography (OCT) is a technique of acquiring a tomographic image of a measurement object by using light interference, and has been put into practical use since 1996 in the field of fundus examination. In recent years, the technique has been considered to be applied to various fields such as cardiology, dentistry, oncology, food industry and regenerative medicine.

US2014/0204388 discloses a technique related to the OCT. As disclosed in the document, in the OCT, light from a light source is branched into two of signal light to be irradiated to a measurement object and reference light to be reflected by a reference light mirror without irradiating the measurement object, the signal light reflected from the measurement object is multiplexed and caused to interfere with the reference light, and thereby a measurement signal is obtained.

The OCT is largely divided into a time domain OCT and a Fourier domain OCT by a scanning method (hereinafter referred to as z-scan) in a optical axis direction of a measurement position. In the time domain OCT, a low coherence light source is used as the light source, and z-scan is performed by scanning a reference light mirror at the time of measurement. As a result, only components having the same optical path length as the reference light included in the signal light interfere with each other. An envelope detection is performed on an obtained interference signal, and whereby, a desired signal is demodulated. The Fourier domain OCT is further divided into a wavelength scanning type OCT and a spectral domain OCT. In the wavelength scanning type OCT, a wavelength swept light source capable of scanning a wavelength of an outgoing light is used, z-scanning is performed by scanning the wavelength at the time of measurement, wavelength dependency (interference spectrum) of the detected interference light intensity is Fourier transformed, and thereby, a desired signal is obtained. In the spectral domain OCT, using a broadband light source as a light source, separating the generated interference light by a spectroscope, and detecting the interference light intensity (interference spectrum) for each wavelength component correspond to z-scanning. A desired signal is obtained by Fourier transforming the obtained interference spectrum.

### SUMMARY OF THE INVENTION

In the conventional OCT apparatus described above, the depth resolution is determined by a wavelength bandwidth or a wavelength sweeping width of light. Therefore, a light source having a wide wavelength band such as a superluminescent diode (SLD) or a wavelength swept light source is used. These light sources are more expensive than ordinary laser light sources that generate narrowband light. In addition, due to the wide wavelength band of light to be used, an optical element corresponding to broadband light is necessary, and chromatic dispersion compensation is also indispensable. From these facts, it is difficult to lower the price of the conventional OCT apparatus.

Then, the inventors have invented an optical measuring apparatus disclosed in US2014/0204388. The optical measuring apparatus focuses on and irradiates a measurement object with laser light (signal light) by using an objective lens of a high NA (Numerical Aperture), scans the objective lens to scan a condensing position, and obtain a tomographic image of the measurement object. In the optical measuring apparatus, three-dimensional measurement is made possible by using the principle that a reflected light component from the other than a focus of the objective lens included in the signal light does not apparently interfere with the reference light since a curvature of a wavefront does not coincide with a curvature of a wavefront of the reference light. The principle is fundamentally different from the principle of the conventional OCT apparatus using the SLD or the wavelength swept light source. In this configuration, since an expensive light source is not required, an inexpensive optical image measuring apparatus can be provided. On the other hand, the measurement time tends to be long since it takes a long time to scan the condensing position.

In order to carry out the measurement at high speed, it is conceivable to scan the measurement position by scanning an angle of an optical axis of the signal light. In order to scan the angle of the optical axis of the signal light, for example, an optical component such as a galvano mirror or the like may be arranged in an optical path of the signal light. However, by inserting such an optical component into the optical path of the signal light, an optical path length of the signal light becomes longer, and the optical path length of the reference light also needs to be lengthened accordingly. As a result, the optical measuring apparatus becomes large.

The present invention has been made in view of the above problems, and it is an object of the present invention to provide an optical image measuring apparatus capable of performing measurement at high speed with a compact and inexpensive configuration without using a broadband light source.

An optical image measuring apparatus according to the present invention includes an optical branching unit that branches light emitted from a light source into a signal light and a reference light, and an optical scanning unit that scans an angle of an optical axis of the light emitted from the light source is disposed between the light source and the optical branching unit. This makes it possible to shorten the optical path lengths of the signal light and the reference light, as compared with a case where the optical axis angle of the signal light is scanned after the light emitted from the light source is branched into the signal light and the reference light. Accordingly, it is possible to acquire a tomographic image of a measurement object while miniaturizing the optical image measuring apparatus as compared with the conventional case.

As an example, after the light emitted from the light source is propagated through an optical fiber, the light is emitted to space, and the position of an emitting end of the optical fiber is displaced so that the optical axis angle of the light is scanned before the light is branched into the signal light and the reference light. As a result, it is possible to acquire a tomographic image of a measurement object with a compact and inexpensive configuration as compared with a case of using a mirror-driven scanning means such as a galvano mirror.

As an example, a planar size of a light receiving surface of a photodetector is larger than a range in which interference light is displaced on the light receiving surface by scanning an angle of the optical axis by the optical scanning unit, and the light detector is disposed in a position where the light receiving surface includes the entire range in which the interference light is displaced on the light receiving surface. This makes it possible to accurately detect the total energy of the interference light for the entire measurement regions.

As an example, the optical image measuring apparatus includes a reference light mirror that reflects the reference light to the optical branching unit, and focuses the reference light on the reference light mirror with a lens. Even if the optical axis angle of the light emitted from the light source is scanned, the reference light returns to the optical branching unit at the same angle as when the branching is performed, so that the decrease in the signal strength due to the reduction in the interference efficiency between the signal light and the reference light can be suppressed.

As an example, the condensing position in an optical axis direction of an objective lens that focuses the signal light to the measurement object can be changed. As a result, it is possible to acquire a tomographic image at an arbitrary optical axis position of the measurement object.

As an example, the optical image measuring apparatus estimates a particle size distributed in the measurement object based on the strength of the reflected light reflected from the measurement object. Thereby, size distribution of particles smaller than spatial resolution of the optical image measuring apparatus can be measured.

As an example, the optical image measuring apparatus includes a first wavelength light source that emits light of a first wavelength and a second wavelength light source that emits light of a second wavelength different from the first wavelength, and the first wavelength light source and the second wavelength light source alternately emit light. Thus, the wavelength dependency of reflectivity of the measurement object can be evaluated. Therefore, more diverse information about the measurement object can be acquired.

As an example, by multiplexing the signal light and the reference light, three or more interference lights having different phase relationships from each other are generated. As a result, a stable signal that is independent of a phase difference between the signal light and the reference light can be obtained. Therefore, a tomographic image with higher accuracy of the measurement object can be acquired.

As an example, the light emitted from the light source propagates in the space without passing through a member that mediates the propagation of light. Accordingly, a high-resolution image that is the measurement object with an inexpensive configuration can be acquired without using a broadband light source.

According to the present invention, an optical image measuring apparatus capable of carrying out measurement at high speed with a compact and inexpensive configuration can be provided without using a broadband light source such as an SLD or a wavelength swept light source. The problems, configurations, and effects other than those described above will be clarified by the description of the embodiments below.

### BRIEF DESCRIPTION OF THE DRAWINGS

FIG. 1 is a schematic diagram showing a configuration of an optical image measuring apparatus 100 according to a first embodiment;

FIG. 2 is a schematic diagram showing a configuration of an optical image measuring apparatus 100 according to a second embodiment;

FIG. 3 is a schematic diagram showing an example of a measurement object 112;

FIG. 4 is an example of an xy image (a tomographic image in a plane perpendicular to an optical axis) of the measurement object 112 in the second embodiment;

FIG. 5 is a flowchart illustrating a procedure of measuring a size of a particle 302 by the optical image measuring apparatus 100;

FIG. 6 is an example of particle size distribution; and

FIG. 7 is a schematic diagram showing a configuration of an optical image measuring apparatus 100 according to a third embodiment.

### DESCRIPTION OF THE PREFERRED EMBODIMENTS

### First Embodiment: Device Configuration

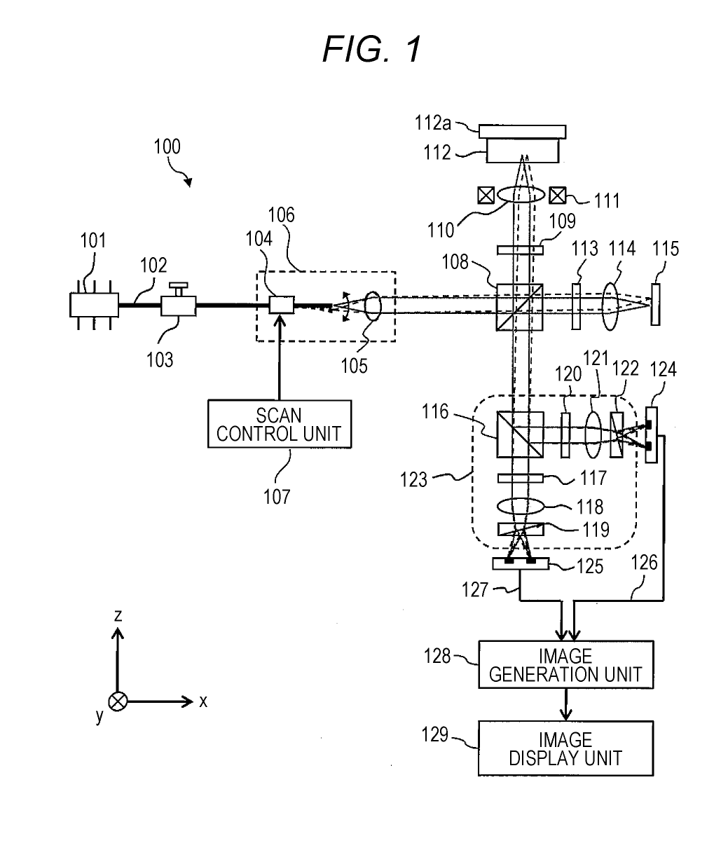

FIG. 1 is a schematic diagram showing a configuration of an optical image measuring apparatus 100 according to a first embodiment of the present invention. Laser light emitted from a light source 101 propagates through an optical fiber 102. A polarization controller 103 adjusts a polarization state of the laser light. The laser light emitted from the polarization controller 103 is guided to a fiber scanner 106. The fiber scanner 106 is composed of a part of the optical fiber 102, a piezo actuator 104, and a collimator lens 105. A scan control unit 107 controls the piezo actuator 104.

The piezo actuator 104 induces resonance vibration at an emitting end of the optical fiber 102. Due to this vibration, the emitting end position of the optical fiber 102 is two-dimensionally driven in a perpendicular plane to the optical axis. As a result, an optical axis angle of the laser light converted into parallel light by the collimator lens 105 is two-dimensionally scanned. A typical resonance frequency of the emitting end of the optical fiber 102 is about 10 to 40 kHz. As a trajectory of the emitting end position of the optical fiber 102, for example, a spiral pattern or the like can be considered.

The light emitted from the optical fiber 102 and passing through the collimator lens 105 propagates through the space where a polarization beam splitter 108 is disposed. No optical element that mediates the propagation of light is disposed in this space. The advantages of this will be described later.

The polarization beam splitter 108 branches the laser light emitted from the fiber scanner 106 into the signal light and the reference light. The branch ratio between the signal light and the reference light can be freely adjusted by the polarization controller 103, and the typical strength ratio is 1:1. A polarization state of the signal light reflected by the polarization beam splitter 108 is converted from s-polarization to circularly polarization by a λ/4 plate 109 whose optical axis direction is set at about 22.5 degrees with respect to a horizontal direction, and then the signal light is focused to the measurement object 112 by the objective lens 110, and the measurement object 112 is irradiated with the signal light. The condensing position of the signal light is two-dimensionally scanned in a perpendicular plane to the optical axis by scanning the optical axis angle of the laser light by the fiber scanner 106.

An objective lens actuator 111 can drive the position of the objective lens 110 along the optical axis direction of the signal light. As a result, two-dimensionally scanning can be performed by focusing the signal light on an arbitrary optical axis direction position. The position along the optical axis direction of the measurement object 112 may be driven by driving a stage 112a on which the measurement object 112 is placed in place of or in combination with the objective lens 110. An arbitrary position in a depth direction of the measurement object 112 can be measured by displacing the condensing position along the optical axis.

The signal light reflected from the measurement object 112 again passes through the objective lens 110, a polarization state of the signal light is converted from circular polarization to p-polarization by the λ/4 plate 109, and the signal light is incident on the polarization beam splitter 108. The measurement object 112 is made of a substance that transmits light to a certain extent and may be anything as long as observation of an internal structure is desired noninvasively. Examples include multilayered structures of semiconductors, foods, plants, cultured cells, human tissues, biopharmaceuticals, and the like.

A polarization state of the reference light is converted from p-polarization to circularly polarization by a λ/4 plate 113 whose optical axis direction is set at about 22.5 degrees with respect to the horizontal direction, and then the reference light is focused to the reference light mirror 115 by the reference light lens 114 having the same structure as the objective lens 110, and the reference light mirror 115 is irradiated with the reference light. The reference light mirror 115 is disposed at a focus position of the reference light lens 114.

The reference light reflected from the reference light mirror 115 again passes through the reference light lens 114, a polarization state of the reference light is converted from circular polarization to s-polarization by the λ/4 plate 113, and the reference light is incident on the polarization beam splitter 108. At this time, since the reference light lens 114 having the same structure as that of the objective lens 110 is used, the amount of aberration given to the signal light by the objective lens 110 and the amount of aberration given to the reference light by the reference light lens 114 are always substantially equal regardless of a displacement amount of the optical axis angle by the fiber scanner 106. Thus, even if the optical axis angle is scanned, variation in the interference efficiency between the signal light and the reference light can be suppressed.

The polarization beam splitter 108 multiplexes the signal light and the reference light to generate synthesized light. The synthesized light is guided to an interference optical system 123. The interference optical system 123 has a half beam splitter 116, a λ/2 plate 117, a λ/4 plate 120, condenser lenses 118 and 121, and Wollaston prisms 119 and 122. The synthesized light incident on the interference optical system 123 is branched into two of transmitted light and reflected light by the half beam splitter 116.

The synthesized light transmitted through the half beam splitter 116 is transmitted through the λ/2 plate 117 whose optical axis is set at about 22.5 degrees with respect to the horizontal direction, then collected by the condenser lens 118, and polarization separated by the Wollaston prism 119. As a result, first interference light and second interference light having mutually different phase relationships by 180 degrees are generated. The first interference light and the second interference light are detected by a current differential type photodetector 125. The photodetector 125 outputs a differential output signal 127 that is proportional to the strength difference of each interference light.

The synthesized light reflected by the half beam splitter 116 is transmitted through the λ/4 plate 120 whose optical axis is set at about 45 degrees with respect to the horizontal direction, then focused by the condenser lens 121, and is polarization separated by the Wollaston prism 122. As a result, third interference light and fourth interference light having mutually different phase relationships by about 180 degrees are generated. The third interference light is different in phase from the first interference light by about 90 degrees. The third interference light and the fourth interference light are detected by a current differential type photodetector 124. The photodetector 124 outputs a differential output signal 126 proportional to the strength difference of each interference light.

As the fiber scanner 106 scans the optical axis angle, light spots is displaced on the light receiving surfaces of the photodetectors 124 and 125, respectively. The photodetectors 124 and 125 are configured to cover the displacement. In other words, the size of the light receiving surface of each photodetector is larger than the moving amount of the light spot, and each photodetector is disposed at a position capable of covering the entire movement range of the light spot. This makes it possible to accurately detect the total energy of the interference light for all measurement regions of the measurement object 112.

An image generation unit 128 receives differential output signals 126 and 127. The image generation unit 128 generates an image of the measurement object 112 based on these signals. An image display unit 129 displays the image.

### First Embodiment: Spatial Resolution

The spatial resolution in the optical axis direction (the depth direction of the measurement object 112) of the optical image measuring apparatus 100 will be described. In the first embodiment, the reflected light component from other than the focus of the objective lens 110 included in the signal light has a defocus aberration. On the other hand, a wavefront shape of the reference light is flat. Therefore, since the reflected light component from other than the focus does not have the same wave front shape as that of the reference light, the reflected light component from other than the focus does not spatially uniformly interfere with the reference light. As a result, many interference fringes are formed on the light receiving surface of the photodetector. When such an interference fringe is formed, the value obtained by integrating the strength of the detected interference light within the light receiving surface is substantially equal to the sum of the intensities of the signal light and the reference light. That is, the differential output signals 126 and 127 corresponding to the reflected light component from the other than the focus of the objective lens 110 are substantially zero. According to such a principle, the reflected light component from other than the focus of the objective lens 110 effectively does not interfere with the reference light, only the reflected light component from the focus of the objective lens 110 is selectively detected, and high z-resolution can be achieved.

The z resolution is determined by a numerical aperture NA of the objective lens 110 and a wavelength λ of the laser light, and is proportional to λ/NA². Generally, the wavelength of light used in the OCT apparatus is about 600 nm to 1300 nm, which is hardly absorbed by both hemoglobin and water. For example, if the numerical aperture of the objective lens 110 is 0.4 or more, the spatial resolution in the optical axis direction at wavelengths from 600 nm to 1300 nm is about 3.3 μm to about 7.2 μm.

According to the above principle, the light emitted from the optical fiber 102 interferes in the space where each optical element is disposed, and whereby, high resolution can be realized by using an inexpensive light source. On the other hand, in the conventional configuration utilizing the principle described above, since the xy coordinate is scanned by driving the objective lens 110 by the actuator, the operating frequency is slow. Therefore, in the first embodiment, the xy coordinate is scanned at a high speed by driving the optical fiber 102 while taking advantage of the above principle.

In order to obtain high z-resolution based on the above principle, the signal light reflected from the measurement object 112 needs to be multiplexed with the reference light while holding wavefront information. For example, if the fiber scanner 106 is applied to the signal light that has been branched into the signal light and the reference light, since the signal light loses the wavefront information at the time of entering the optical fiber, high z-resolution cannot be obtained. In the first embodiment, by disposing the fiber scanner 106 in a front stage of the polarization beam splitter 108, there is an advantage that scanning of the optical axis at high speed and high z-resolution can be achieved at the same time.

### First Embodiment: Optical System

The function of the interference optical system 123 will be described using formulae. The Jones vector of the synthesized light at the time of entering the interference optical system 123 is represented by Formula 1 described below.

$$\begin{matrix}[ Formula 1 ] & \\ ( \begin{matrix}{E}_{sig} \\ {E}_{ref}\end{matrix} ) & ( 1 )\end{matrix}$$

The Jones vector of the synthesized light after transmitting through the half beam splitter 116 and the λ/2 plate 117 is represented by Formula 2 described below. E_{sig} represents complex amplitude of the signal light, and E_{ref} represents complex amplitude of the reference light.

$$\begin{matrix}[ Formula 2 ] & \\ ( \begin{matrix}1 \text{/} \sqrt{2} & - 1 \text{/} \sqrt{2} \\ 1 \text{/} \sqrt{2} & 1 \text{/} \sqrt{2}\end{matrix} ) ( \begin{matrix}{E}_{sig} \text{/} \sqrt{2} \\ {E}_{ref} \text{/} \sqrt{2}\end{matrix} ) = \frac{1}{2} ( \begin{matrix}{E}_{sig} - {E}_{ref} \\ {E}_{ref} + {E}_{ref}\end{matrix} ) & ( 2 )\end{matrix}$$

The synthesized light represented by Formula 2 is branched into two of a p-polarized light component and an s-polarized light component by the Wollaston prism 119, and then differentially detected by a current differential type photodetector 125. At this time, the differential output signal 127 output from the photodetector 125 is represented by Formula 3 described below. θ_{sig} and θ_{ref} are the phases when a complex numbers E_{sig} and E_{ref} are represented by polar coordinates. For simplicity, conversion efficiency of the photodetector is set to 1.

$$\begin{matrix}[ Formula 3 ] & \\ \begin{matrix}I = \frac{1}{4} {\vert {E}_{sig} + {E}_{ref} \vert}^{2} - \frac{1}{4} {\vert {E}_{sig} - {E}_{ref} \vert}^{2} \\ = \vert {E}_{sig} \vert \vert {E}_{ref} \vert cos ( {θ}_{sig} - {θ}_{ref} )\end{matrix} & ( 3 )\end{matrix}$$

The Jones vector of the synthesized light after reflected by the half beam splitter 116 and transmitting through the λ/4 plate 120 is represented by Formula 4 described below.

$$\begin{matrix}[ Formula 4 ] & \\ ( \begin{matrix}i \text{/} \sqrt{2} & 1 \text{/} \sqrt{2} \\ 1 \text{/} \sqrt{2} & i \text{/} \sqrt{2}\end{matrix} ) ( \begin{matrix}{E}_{sig} \text{/} \sqrt{2} \\ {E}_{ref} \text{/} \sqrt{2}\end{matrix} ) = \frac{1}{2} ( \begin{matrix}i ( {E}_{sig} - {iE}_{ref} ) \\ {E}_{sig} + {iE}_{ref}\end{matrix} ) & ( 4 )\end{matrix}$$

The synthesized light represented by Formula 4 is branched into two of a p-polarized light component and an s-polarized light component by the Wollaston prism 122, and then differentially detected by a current differential type photodetector 124. At this time, the differential output signal 126 output from the photodetector 124 is represented by Formula 5 described below.

$$\begin{matrix}[ Formula 5 ] & \\ \begin{matrix}Q = \frac{1}{4} {\vert {E}_{sig} + {iE}_{ref} \vert}^{2} - \frac{1}{4} {\vert {E}_{sig} - {iE}_{ref} \vert}^{2} \\ = \vert {E}_{sig} \vert \vert {E}_{ref} \vert sin ( {θ}_{sig} - {θ}_{ref} )\end{matrix} & ( 5 )\end{matrix}$$

The image generation unit 128 performs the calculation of Formula 6 described below with respect to the signals represented by Formulae 3 and 5 to generate a reflection signal strength S that is proportional to an absolute value of the amplitude of the signal light not depending on the phase difference between the signal light and the reference light.

[Formula 6]

S=|E_{sig}|²|E_{ref}|²|=I²+Q² (6)

### First Embodiment: Conclusion

In the optical image measuring apparatus 100 according to the first embodiment, the fiber scanner 106 is disposed before the polarization beam splitter 108 branches the light into the signal light and the reference light, and the optical axis angle is scanned. In this configuration, unlike the case where the polarization beam splitter 108 branches the light into the signal light and the reference light, and then the fiber scanner 106 scans the optical axis angle of the signal light, the signal light reflected from the measurement object 112 is multiplexed with the reference light without propagating through an optical fiber (thus maintaining the wavefront information). Therefore, as described above, high z-resolution (spatial resolution in the optical axis direction) can be achieved.

In the optical image measuring apparatus 100 according to the first embodiment, an angular scanning element (not limited to a fiber scanner but a galvanometer mirror, a MEMS mirror, a polygon mirror or the like also can be used) is not disposed on the optical path of the signal light. Therefore, since the optical path length is not increased by inserting the angular scanning element on the optical path of the signal light, it is unnecessary to increase the optical path length of the reference light in accordance with the increase in the optical path length of the signal light. Therefore, there is an advantage that the size of the optical system can be reduced.

### Second Embodiment

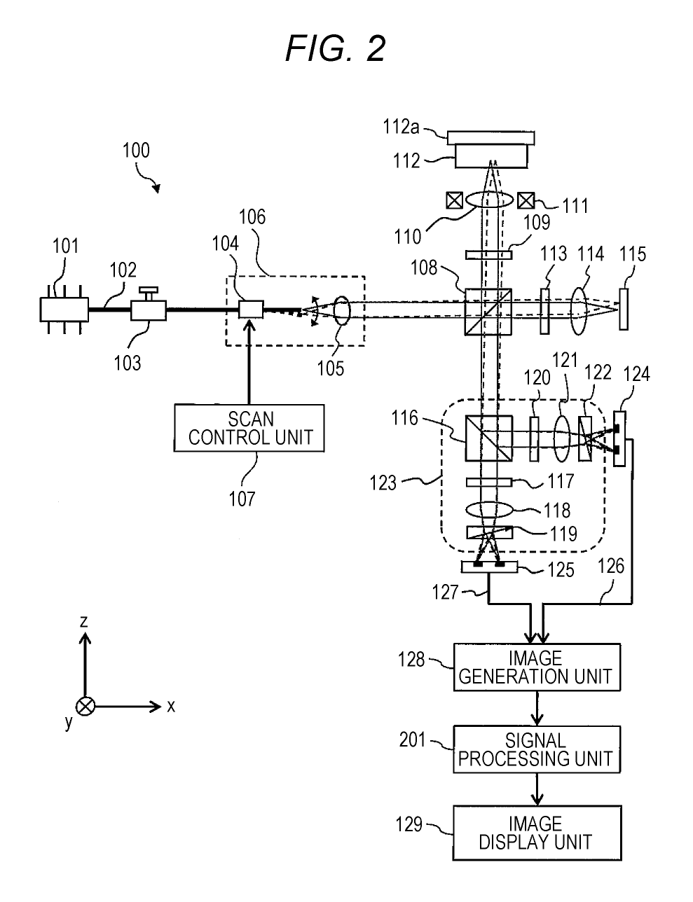

FIG. 2 is a schematic diagram showing the configuration of the optical image measuring apparatus 100 according to a second embodiment of the present invention. The optical image measuring apparatus 100 according to the second embodiment includes a signal processing unit 201 in addition to the configuration described in the first embodiment. The signal processing unit 201 calculates particle size distribution included in the measurement object 112 based on the detection signal. Other configurations are the same as those in the first embodiment.

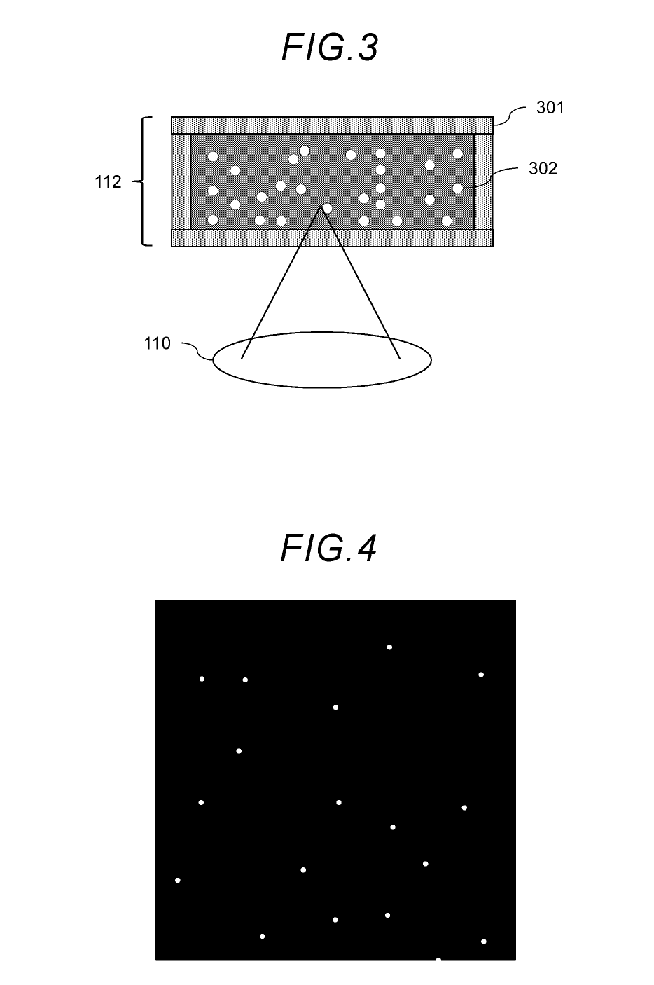

FIG. 3 is a schematic diagram showing an example of the measurement object 112. In the second embodiment, as the measurement object 112, one in which the particles 302 of various sizes sealed in a glass cell 301 are suspended in liquid is measured. An example of such a measurement object 112 is a biopharmaceutical. Various sizes (several nm to several hundred μm) of protein agglomerates (particles) are contained in biopharmaceuticals, and it is suggested that these aggregates may adversely affect the human body depending on concentration. Therefore, it is necessary to measure the size of the aggregate as a quality inspection of pharmaceutical products.

For a particle larger than the spatial resolution of the optical image measuring apparatus 100, the size of the particle can be directly evaluated from the acquired image. However, for particles smaller than spatial resolution, its size can not be evaluated directly from the image. Therefore, in the second embodiment, the size of particles smaller than the spatial resolution is estimated based on the reflection signal strength from each particle.

When the particles smaller than the spot size of when the signal light is condensed by the objective lens 110 is irradiated with the signal light, if the light spot size of the signal light is Rₛₚₒₜ, and the particle radius is R_{particle}, the reflection signal strength S represented by Formula 6 is considered to be proportional to the square of the ratio of the Rₛₚₒₜ and R_{particle}. That is, the reflection signal strength S can be represented by Formula 7 described below. α is a proportional coefficient depending on a refractive index of the particle.

$$\begin{matrix}[ Formula 7 ] & \\ S = {α ( \frac{{R}_{particle}}{{R}_{spot}} )}^{2} & ( 7 )\end{matrix}$$

By obtaining the value of a beforehand, from a measurement result of standard beads with well-known particle size and refractive index, the size of particles smaller than the spatial resolution from the reflection signal strength S can be obtained by using the relationship of Formula 7. In the following description, it is assumed that the sizes of the particles 302 included in the measurement object 112 are all smaller than the spatial resolution for simplicity of explanation.

FIG. 4 is an example of an xy image (a tomographic image in a plane perpendicular to an optical axis) of the measurement object 112 in the second embodiment. The particle 302 appears as a bright spot in the acquired xy image and the size of the particle 302 can not be discriminated from the size of the bright spot, but the brightness (reflection signal strength) of each bright spot includes information on the size of the particle.

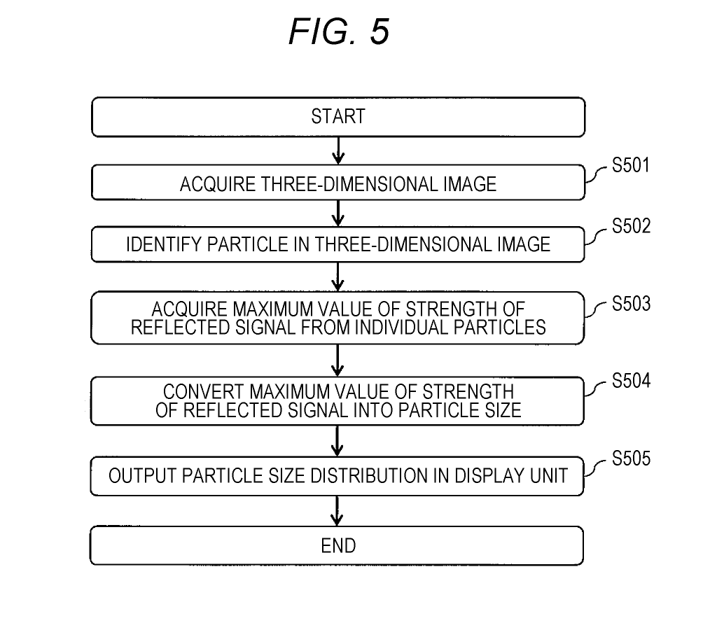

FIG. 5 is a flowchart illustrating a procedure of measuring a size of a particle 302 by the optical image measuring apparatus 100. Each step of FIG. 5 will be described below.

### (FIG. 5: Step S501)

When the reflection signal strength is converted into the particle size, it is necessary to use the reflection signal strength at a state where the reflection signal strength from the particle 302 of interest is the maximum (that is, a z-position where the spot size of the signal light becomes the minimum). Therefore, the signal processing unit 201 repeatedly acquires the xy image while changing the z-position to be measured, and generates a three-dimensional image of the measurement object 112.

### (FIG. 5: Steps S502 to S505)

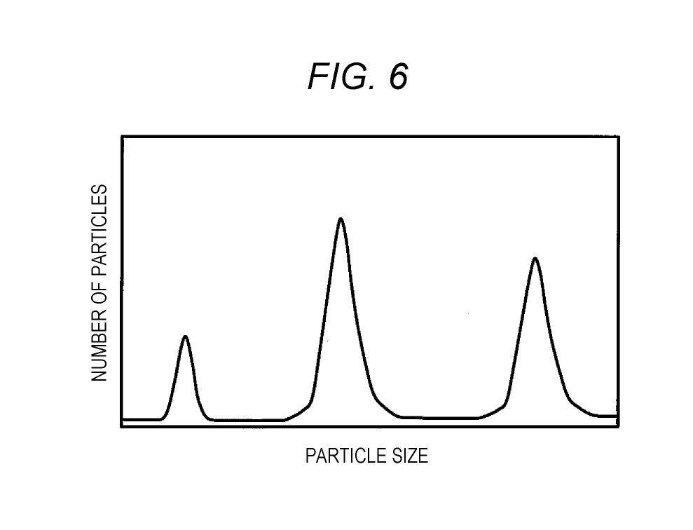

The signal processing unit 201 identifies the presence of particles from the three-dimensional image (S502). The signal processing unit 201 acquires the maximum value of the reflection signal strength of each particle (S503). The signal processing unit 201 converts the reflection signal strength into a particle size based on the relationship of Formula 7. (S504). The signal processing unit 201 displays a particle size distribution as shown in FIG. 6 described later, on the image display unit 129 (S505).

FIG. 6 is an example of particle size distribution. The signal processing unit 201 can estimate the size of each particle 302 according to the flowchart of FIG. 5. The signal processing unit 201 calculates the distribution of the size and the number of the particles 302 and displays the distribution on the image display unit 129, for example, in the display format as shown in FIG. 6.

### Second Embodiment: Conclusion

The optical image measuring apparatus 100 according to the second embodiment estimates the size of the particle 302 based on the reflection signal strength S. Thereby, the size of the particles 302 smaller than the spatial resolution of the optical image measuring apparatus 100 can be obtained.

### Third Embodiment

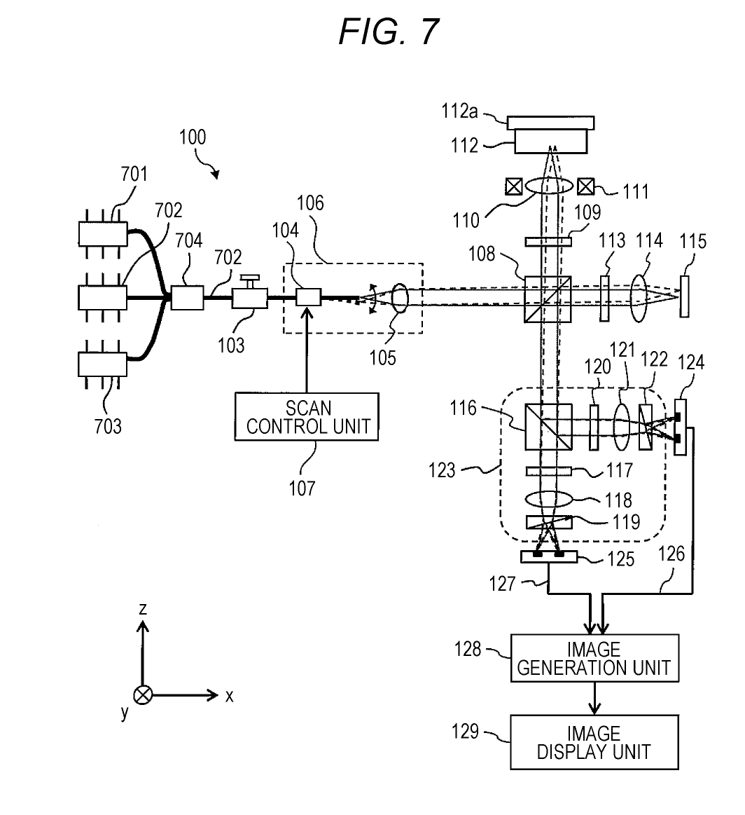

FIG. 7 is a schematic diagram showing a configuration of an optical image measuring apparatus 100 according to a third embodiment of the present invention. The optical image measuring apparatus 100 according to the third embodiment includes three light sources 701, 702, and 703, each having a different wavelength, and an optical multiplexer 704, in place of the light source 101. Other configurations are the same as those in the first embodiment.

The light source 701, the light source 702, and the light source 703 respectively emit first laser light, second laser light, and third laser light having different wavelengths. Each laser light propagates through the optical fiber 102 and is guided to the optical multiplexer 704. The light sources 701 to 703 temporally alternately emit light with a repetition frequency higher than the driving frequency of the fiber scanner 106, and one of the light sources always emits light. More specifically, during a time when the fiber scanner 106 moves the condensing position of the signal light by an amount corresponding to one pixel of the acquired image, the light sources 701 to 703 alternately emit light at a frequency in which each of the light sources 701 to 703 emits light at least one time.

While the fiber scanner 106 scans the optical axis angle with respect to the measurement position corresponding to one pixel on the measurement object 112, the optical image measuring apparatus 100 according to the third embodiment can acquire a tomographic image for a plurality of wavelengths. Thus, information on the wavelength dependency of the reflectivity of the measurement object 112 can be acquired.

In the third embodiment, since laser lights having different wavelengths are emitted from the same optical fiber to space, the optical axes of the respective laser lights substantially coincide. This makes it possible to accurately measure the same region of the measurement object 112 using lights having different wavelengths.

In the third embodiment, the light sources 701 to 703 are caused to emit light alternately, so that the irradiation timing with respect to the measurement object 112 is differentiated. Instead of this, for example, an optical switch may be provided in place of the optical multiplexer 704, and by controlling the optical switch, the laser light to be transmitted can be alternately switched.

### Modification of the Present Invention

The present invention is not limited to the embodiments described above, but includes various modifications. The embodiments described above have been described in detail in order to explain the present invention in a comprehensible manner and are not necessarily limited to those having all the configurations described. Further, a part of the configuration of one embodiment can be replaced by the configuration of another embodiment, and the configuration of another embodiment can be added to the configuration of one embodiment. Further, other configurations can be added, deleted, and replaced with respect to part of the configuration of each embodiment.

The image generation unit 128 and the signal processing unit 201 may be configured using hardware such as a circuit device that implements these functions, or are configured by executing software that implements these functions by a calculation device.

In the above embodiments, four interference light beams are generated in the interference optical system 123. However, in order to obtain a signal independent of the phase, any number of interference light beams may be used as long as the number of interference light beams is three or more.

What is claimed is:

1. An optical image measuring apparatus configured to acquire an image of an measurement object, the optical image measuring apparatus comprising:
a light source that emits light;
an optical branching unit that branches the light emitted from the light source into a signal light and a reference light;
an optical scanning unit that is disposed between the light source and the optical branching unit and scans an angle of an optical axis of the light emitted from the light source;
an interference optical system that generates interference light by multiplexing the signal light reflected from the measurement object and the reference light; and
a photodetector that detects the interference light.

2. The optical image measuring apparatus according to claim 1, wherein
the optical image measuring apparatus further includes an optical fiber that receives the light emitted from the light source and emits the light to the optical branching unit, and
the optical scanning unit includes an optical fiber driving unit that scans the angle of the optical axis by displacing a position of an emitting end at which the optical fiber emits light to the optical branching unit.

3. The optical image measuring apparatus according to claim 1, wherein
a planar size of a light receiving surface of the photodetector is larger than a range in which the interference light is displaced on the light receiving surface by scanning the angle of the optical axis by the optical scanning unit, and
the photodetector is disposed at a position where the light receiving surface completely includes a range where the interference light is displaced on the light receiving surface.

4. The optical image measuring apparatus according to claim 1, further comprising:
a reference light mirror that returns the reference light to the optical branching unit by reflecting the reference light emitted from the optical branching unit; and
a lens that focuses the reference light to the reference light mirror.

5. The optical image measuring apparatus according to claim 1, further comprising:
an objective lens that is disposed between the optical branching unit and the measurement object and focuses the signal light to the measurement object; and
a drive unit for displacing a condensing position of the objective lens along an optical axis direction of the signal light.

6. The optical image measuring apparatus according to claim 1, wherein
the optical image measuring apparatus further comprises:
an objective lens that is disposed between the optical branching unit and the measurement object and focuses the signal light to the measurement object; and
a stage on which the measurement object is placed, and
the stage is configured so as to be able to displace a position of the measurement object along an optical axis direction of the signal light.

7. The optical image measuring apparatus according to claim 1, wherein
the optical image measuring apparatus further includes a signal processing unit that obtains a size distribution of particles distributed in the measurement object, and
the signal processing unit estimates the size of the particles based on strength of reflected light reflected from the measurement object.

8. The optical image measuring apparatus according to claim 1, wherein
the light source has a first wavelength light source that emits light of a first wavelength and a second wavelength light source that emits light of a second wavelength different from the first wavelength, and
the first wavelength light source and the second wavelength light source alternately emit light.

9. The optical image measuring apparatus according to claim 8, wherein
the optical image measuring apparatus further includes a calculation unit that generates image data of the measurement object by using the interference light detected by the light detector, and
the light source performs at least once, operation of emitting light by the first wavelength light source and operation of emitting light by the second wavelength light source within time in which a scanning position on the measurement object of the signal light moves a distance corresponding to one pixel of the image data by the optical scanning unit.

10. The optical image measuring apparatus according to claim 1, wherein
the optical scanning unit is configured by using a mirror that changes an angle of the optical axis by reflecting the light emitted from the light source.

11. The optical image measuring apparatus according to claim 1, wherein
the interference optical system generates three or more of the interference light having mutually different phase relationships.

12. The optical image measuring apparatus according to claim 1, wherein
the optical scanning unit is configured to emit the light toward space where the optical branching unit is disposed,
the optical image measuring apparatus does not include an optical member that mediates propagation of the light between the optical scanning unit and the optical branching unit, and
light emitted from the light source propagates through the space.
